(19) United States
(12) Patent Application Publication
(10) Pub. No.: US 2024/0338628 A1
(43) Pub. Date: Oct. 10, 2024

(54) RULE-BASED AND ARTIFICIAL INTELLIGENCE-BASED HYBRID ANALYTICS FOR ACTION FACILITATION

(71) Applicant: Zoom Video Communications, Inc., San Jose, CA (US)

(72) Inventors: Wei Ji, San Jose, CA (US); Bilung Lee, San Jose, CA (US); Prasad Methil, San Jose, CA (US); Vijay Venkataswamy Parthasarathy, San Jose, CA (US)

(73) Assignee: Zoom Video Communications, Inc., San Jose, CA (US)

(21) Appl. No.: 18/228,296

(22) Filed: Jul. 31, 2023

Related U.S. Application Data
(60) Provisional application No. 63/457,278, filed on Apr. 5, 2023.

(51) Int. Cl. G06Q 10/0635; G06Q 10/0637; G06Q 10/10

(52) U.S. Cl. CPC G06Q 10/0635; G06Q 10/06375; G06Q 10/103

(57) ABSTRACT

Systems and methods for providing rule-based and AI-based hybrid analytics to facilitate actions for a project are provided. A communication analytics platform accesses project metadata and communication data associated with a project. The communication analytics platform determines a first risk score of the project based on the project metadata and the communication data using a rule-based analytics model. The communication analytics platform determines a second risk score of the project based on the project metadata and the communication data using an artificial intelligence (AI)-based analytics model. The communication analytics platform determines a risk level of the project based on the first risk score and the second risk score. The communication analytics platform provides a notification message based on the risk level to a user associated with the project.

### CROSS-REFERENCE TO RELATED APPLICATIONS

This application claims priority from U.S. Provisional Patent Application No. 63/457,278, filed Apr. 5, 2023, titled “RULE-BASED AND ARTIFICIAL INTELLIGENCE (AI)-BASED HYBRID ANALYTICS FOR ACTION FACILITATION,” the entirety of which is hereby incorporated by reference.

### FIELD

The present application generally relates to data analytics and more specifically relates to rule-based and artificial intelligence (AI)-based hybrid analytics for action facilitation.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system that provides videoconferencing functionality to various client devices;

FIG. 2 shows an example system in which a chat and video conference provider provides videoconferencing functionality to various client devices;

FIG. 3 shows an example system that provides rule-based and AI-based hybrid analytics to facilitate actions for a project;

FIG. 4 shows an example system that is configured to automatically determine a risk level of a project using rule-based and AI-based analytics models to facilitate next-step actions for a project;

FIG. 5 is an example GUI displaying a list of deals with corresponding indicators about triggered rules;

FIG. 6 is an example GUI displaying a list of deals with corresponding indicators about risk levels;

FIG. 7 is an example GUI displaying a list of deals with corresponding indicators about risk scores;

FIG. 8 is an example GUI displaying a deal risk summary for a selected deal;

FIG. 9 shows an example method for automatically analyzing project related data and facilitating actions for a project using rule-based and AI-based analytics models;

FIG. 10 shows an example computing device suitable for use in example systems or methods for automatically analyzing project related data and facilitating actions for a project using rule-based and AI-based analytics models.

### DETAILED DESCRIPTION

Examples are described herein in the context of rule-based and artificial intelligence (AI)-based hybrid analytics for action facilitation. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

An entity may interact with several other entities for different projects. These entities communicate via multiple different means, for example, video conferencing, phone calls, emails, online chats, or in-person meetings. Data related to the communication also spread over the different channels. Analyzing all the data across different channels over a period of time manually is tedious. When an entity simultaneously works on multiple projects with various other entities, it is hard for the entity to track the progress of all the projects manually and determine what actions needs to be taken for which project in a timely manner.

To monitor a project and facilitate entity actions on the project, it is desirable for a communication analytics platform to automatically analyze project related data using rule-based and AI-based analytics models to determine a risk level for each project and generate a recommendation of next-step action. For example, the communication analytics platform is integrated with third-party platforms, such as project management or customer relationship management (CRM) platforms. The third-party platforms include information about different projects (e.g., product developments, business deals, etc.) involving different teams or parties. The communication analytics platform is also integrated with different communication channels, for example, video conferences, phone calls, online chats, or on-line calendars. The different communication channels can be provided by one communication provider or by multiple different communication providers.

The communication analytics platform extracts a list of projects from the third-party platforms. A user can set some or all of the projects to be monitored by the communication analytics platform automatically. The user may define certain rules to trigger notification or further action. For example, a user-defined rule for a deal is that if there have been no communications for two weeks, then identify the deal as at risk, which means further actions need to be taken. The user can define multiple rules for a user project. The user may have multiple user projects monitored by the communication analytics platform and each user project has its own user-defined rules.

The communication analytics platform builds a rule-based analytics model based on the user-defined rules for a user project. The rule-based analytics model can analyze project related data, which can include the communication data from different channels and project metadata. The communication data includes dates, times, durations, parties, channels (e.g., video conferencing, phone calls, emails, online chats, or in-person meetings), and content (e.g., recordings, summaries, or files for video meetings, recordings or summaries for phone calls, emails, chat messages, or summaries or files for in-person meetings) for prior communication occurrences. The project metadata includes information about the project, for example, project name, project value, project stage, involved parties, target dates, contacts, etc. The rule-based analytics model automatically determines if a user-defined rule is triggered based on the analysis of the project related data. Each user-defined rule has a corresponding weight, which can also be pre-defined by the user. The more the user-defined rules are triggered, the more severe the corresponding project is generally determined to be at risk. In other words, the more imminent a next-step action is needed. The rule-based analytics model can determine a risk score based on the number of rules triggered and their weights. The rule-based analytics engine then generates a notification about the triggered rules or the risk score for a corresponding project.

Alternatively, or additionally, the communication analytics platform can train an AI model based on historical project related data from historical projects, including historical communication data, historical project metadata, user-defined rules for the historical projects, and actions taken based on triggered rules. The AI model can learn normal patterns or features for different types of projects from these data. The learned AI model can be implemented to determine a risk score or risk level for a project by analyzing previous communication data and project metadata for the project. The AI-based analytics model can also generate a notification about the risk level for the project.

In some examples, the communication analytics platform uses the rule-based analytics engine and the AI-based analytics engine in parallel to provide a hybrid analysis by combining or selecting the analysis results from the two different engines. The hybrid analysis can provide more accurate notification including specific triggered rules or a risk level about a user project to a user. Further, the communication analytics platform can suggest a communication channel and generate relevant content for the next-step action based on analysis of project related data and the risk score of the project.

The user may take actions based on the notification. For example, the notification indicates the risk score is 86 out of 100 and certain triggered rules (e.g., if there is no response for two weeks, then deal at risk), and recommends a video meeting with counterparties of the project and provide a list of key points to discuss in the video meeting. The user may conduct an internal meeting regarding the recommended video meeting first. Alternatively, the user determines the project is not worth pursuing, and ignores the notification. The following user actions or nonactions can be feedback data provided to the AI-based analytics model to fine-tune the AI-based analytics model.

Thus, this example provides techniques for automatically analyzing project related data using rule-based and AI-based analytics models to determine a risk level for a project or further recommend next-step actions. The communication analytics platform can monitor user projects, detect at-risk user projects, send at-risk notifications, and recommend next-step actions to the user. Thus, the rule-based analytics model and the AI-based analytics models run in the background as virtual assistants to the user to save user time and provide notifications and actionable intelligence to the user for multiple projects.

This illustrative example is given to introduce the reader to the general subject matter discussed herein and the disclosure is not limited to this example. Even though next-step communication is one type of next-step action, but the next-step action can include other non-communicative actions. The following sections describe various additional non-limiting examples and examples of automatically analyzing and facilitating interactions using rule-based and AI-based analytics models.

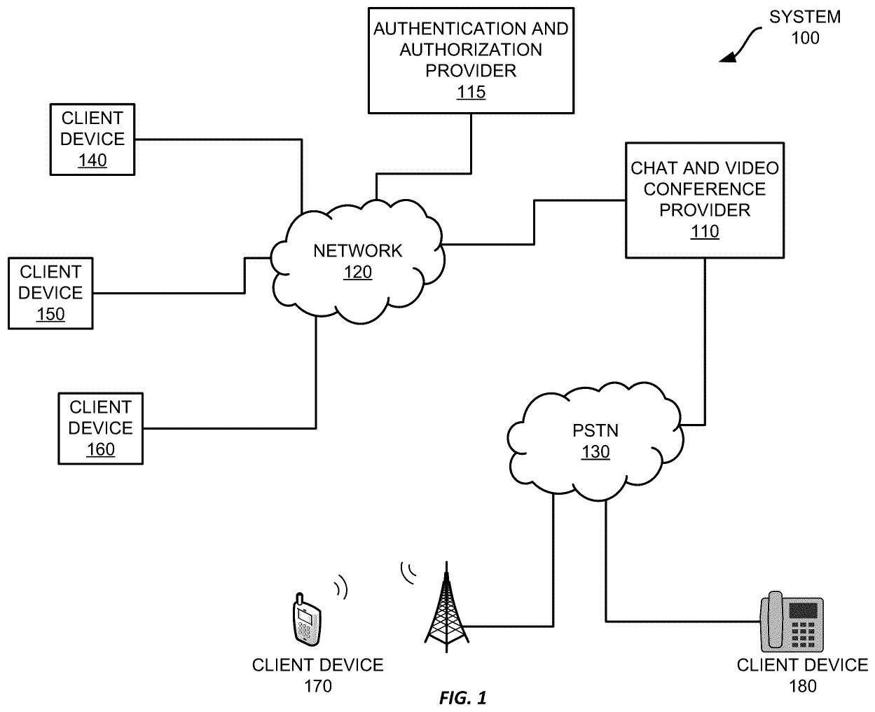

Referring now to FIG. 1, FIG. 1 shows an example system 100 that provides videoconferencing functionality to various client devices. The system 100 includes a chat and video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a chat and video conference provider 110 may supply components to enable a private organization to host private internal video conferences or to connect its system to the chat and video conference provider 110 over a public network.

The system optionally also includes one or more authentication and authorization providers, e.g., authentication and authorization provider 115, which can provide authentication and authorization services to users of the client devices 140-160. Authentication and authorization provider 115 may authenticate users to the chat and video conference provider 110 and manage user authorization for the various services provided by chat and video conference provider 110. In this example, the authentication and authorization provider 115 is operated by a different entity than the chat and video conference provider 110, though in some examples, they may be the same entity.

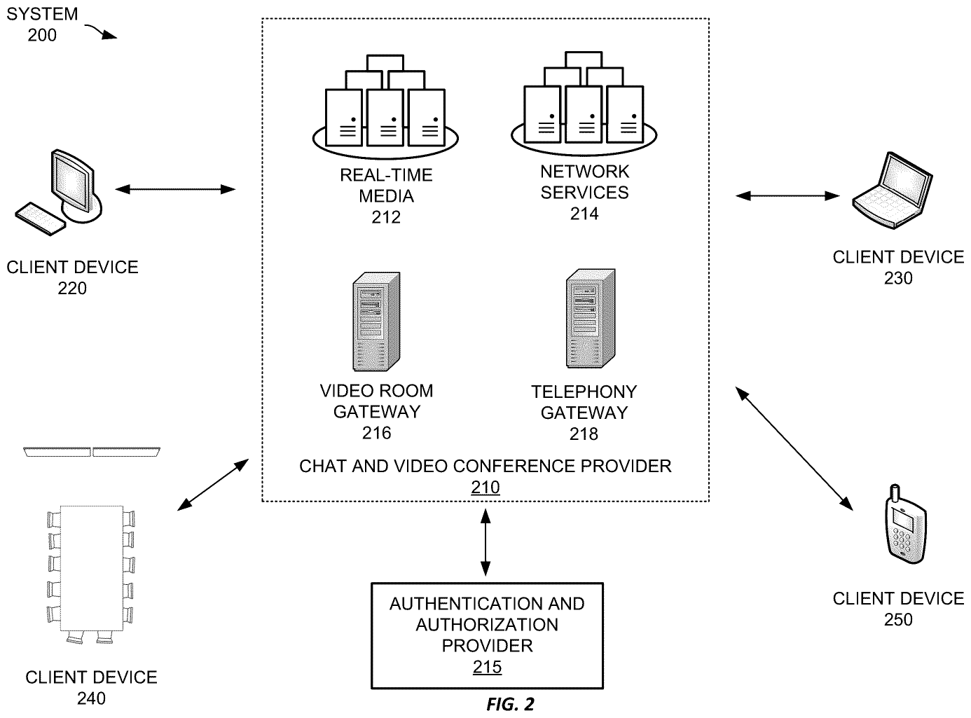

Chat and video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example chat and video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user authentication information, meeting identifiers, meeting passwords or passcodes, etc. In examples that employ an authentication and authorization provider 115, a client device, e.g., client devices 140-160, may operate in conjunction with an authentication and authorization provider 115 to provide authentication and authorization information or other user information to the chat and video conference provider 110.

An authentication and authorization provider 115 may be any entity trusted by the chat and video conference provider 110 that can help authenticate a user to the chat and video conference provider 110 and authorize the user to access the services provided by the chat and video conference provider 110. For example, a trusted entity may be a server operated by a business or other organization with whom the user has created an account, including authentication and authorization information, such as an employer or trusted third-party. The user may sign into the authentication and authorization provider 115, such as by providing a username and password, to access their account information at the authentication and authorization provider 115. The account information includes information established and maintained at the authentication and authorization provider 115 that can be used to authenticate and facilitate authorization for a particular user, irrespective of the client device they may be using. An example of account information may be an email account established at the authentication and authorization provider 115 by the user and secured by a password or additional security features, such as single sign-on, hardware tokens, two-factor authentication, etc. However, such account information may be distinct from functionality such as email. For example, a health care provider may establish accounts for its patients. And while the related account information may have associated email accounts, the account information is distinct from those email accounts.

Thus, a user's account information relates to a secure, verified set of information that can be used to authenticate and provide authorization services for a particular user and should be accessible only by that user. By properly authenticating, the associated user may then verify themselves to other computing devices or services, such as the chat and video conference provider 110. The authentication and authorization provider 115 may require the explicit consent of the user before allowing the chat and video conference provider 110 to access the user's account information for authentication and authorization purposes.

Once the user is authenticated, the authentication and authorization provider 115 may provide the chat and video conference provider 110 with information about services the user is authorized to access. For instance, the authentication and authorization provider 115 may store information about user roles associated with the user. The user roles may include collections of services provided by the chat and video conference provider 110 that users assigned to those user roles are authorized to use. Alternatively, more or less granular approaches to user authorization may be used.

When the user accesses the chat and video conference provider 110 using a client device, the chat and video conference provider 110 communicates with the authentication and authorization provider 115 using information provided by the user to verify the user's account information. For example, the user may provide a username or cryptographic signature associated with an authentication and authorization provider 115. The authentication and authorization provider 115 then either confirms the information presented by the user or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide authentication information to authenticate the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide account information to the chat and video conference provider 110, even in cases where the user could authenticate and employs a client device capable of authenticating the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to chat and video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a chat and video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices, etc.

Referring now to FIG. 2, FIG. 2 shows an example system 200 in which a chat and video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more authentication and authorization providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O) as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting an authentication and authorization provider 215 to verify the provided credentials. Once the user's credentials have been accepted, and the user has consented, the network services servers 214 may perform administrative functionality, like updating user account information, if the user has account information stored with the chat and video conference provider 210, or scheduling a new meeting, by interacting with the network services servers 214. Authentication and authorization provider 215 may be used to determine which administrative functionality a given user may access according to assigned roles, permissions, groups, etc.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may select a user to remove and issue a command through a user interface on their client device. The command may be sent to a network services server 214, which may then disconnect the selected user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

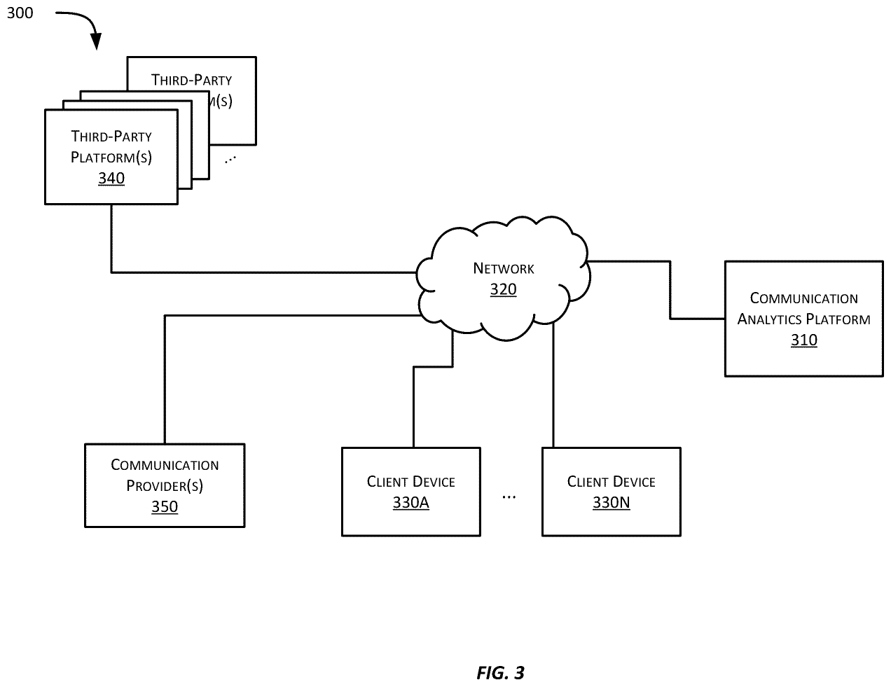

Referring now to FIG. 3, FIG. 3 shows an example system that provides rule-based and AI-based hybrid analytics to facilitate actions for a project. In this example system 300, a communication analytics platform 310 and a number of client device 330A-330N (which may be referred to herein individually as a client device 330 or collectively as the client devices 330) are connected via a network 320. In this example, the network 320 is the internet, however, any suitable communications network or combination of communications network may be employed, including LANs (e.g., within a corporate private LAN) and WANs. The communication analytics platform 310 is integrated with third-party platforms 340 to retrieve data from these third-party platforms 340 via the network 320. The third-party platforms 340 can be CRM platforms, project management platforms, or any platforms where a user can manage or monitor the progress of a project, activity, or relationship with other parties.

The communication provider(s) 350 can be one or more communication platforms including one or more communication channels. A communication provider 350 can be the chat and video conference provider 110 in FIG. 1 or the chat and video conference provider 210 in FIG. 2, providing multiple communication means, for example, video conferencing, phone calls, chat channels, emails, and other suitable communication means. The communication analytics platform 310 can be part of such a communication platform as well.

The client devices 330 can be any suitable computing or communications device. For example, client devices 330 may be desktop computers, laptop computers, tablets, smart phones having processors and computer-readable media, connected to the communication analytics platform 310 using the internet or other suitable computer network. The client devices 330 have communication analytics software installed to enable them to connect to the communication analytics platform 310. A user, via a client device 330, can set which projects to monitor and define rules for the project on the communications analytics platform 310. The communication analytics platform 310 is configured to retrieve and analyze communication data related to a project, determine a risk level, and facilitate next-step actions for the project.

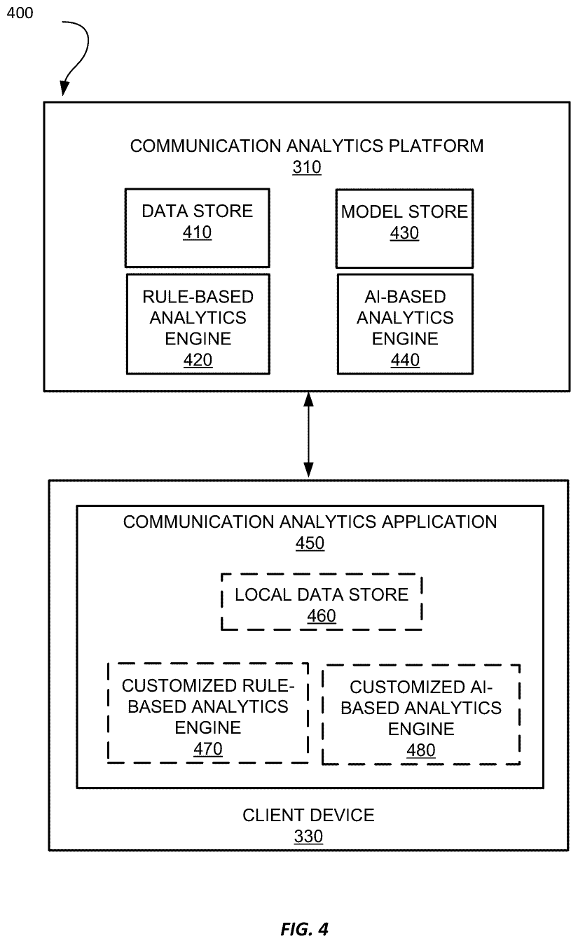

Referring now to FIG. 4, FIG. 4 shows an example system 400 that is configured to automatically determine a risk level of a project using rule-based and AI-based analytics models to facilitate next-step actions for a project. The communication analytics platform 310 is in network communication with a client device 330. The client device 330 is installed with a communication analytics application 450 provided by the communication analytics platform 310. The communication analytics platform 310 is provided by the chat and video conference provider 110 in FIG. 1 or the chat and video conference provider 210 in FIG. 2. The communication analytics platform 310 includes a data store 410, a rule-based analytics engine 420, a model store 430, and an AI-based analytics engine 440.

The communication analytics platform 310 is configured to access project metadata for one or more projects from a third-party platform 340. For example, a client device 330 can transmit a permission (e.g., by way of a login with a username and password) for the communication analytics platform 310 to access of the one or more projects on the third-party platform 340 via a communication analytics application 450. The communication analytics platform 310 can extract project metadata for the one or more projects, for example, including project name, project value, project stage, involved parties, target dates, contact information, etc.

The communication analytics platform 310 is configured to access communication data associated with a project from a communication provider 350, which may or may not be on the same platform as the communication analytics platform 310. A user may select one or more projects for monitoring and import communication data associated with the one or more projects from the communication provider 350 to the communication analytics platform 310. The user can choose a subset of communication data associated with the project. Alternatively, the communication analytics platform 310 can automatically extracts communication data associated with a project from the communication provider. The communication data can be generated in different channels, such as video conferencing, phone calls, emails, chats, or in-person meetings, etc. The communication data can include communication content from different communication channels for different communication occurrences, for example, recordings, files, or summaries of video conferences, recordings, files, or summaries of phone calls, emails, chat messages, summaries of in-person meetings, and any records of any other types of communication occurrences. The communication data also include communication metadata, such as dates, times, durations, and parties associated with different communication occurrences.

The data store 410 is configured to store project metadata retrieved from third-party platforms 340 and communication data imported from the communication providers 350 for one or more on-going projects. In addition, the data store 410 also stores historical project data for historical user projects. In some examples, the data store 410 also stores user-defined rules for different user projects. Additionally, the data store 410 can also store a set of general-purpose rules for a general-purpose project. The set of general-purpose rules, which can be selected from or adapted from a variety of user-defined rules stored in the data store 410, representing different aspects of a general-purpose project. The data store 410 can also store multiple sets of general-purpose rules for corresponding multiple project types (e.g., construction, sales, product development, etc.).

The rule-based analytics engine 420 is configured to analyze project related data using a rule-based analytics model. In some examples, the rule-based analytics model is built with a set of general-purpose rules stored in the data store 410, generally applicable to various projects. The set of general-purpose rules can be translated into a mathematical model (e.g., Markov chains or other equations) or implemented directly on project related data for a particular project. In some examples, the rule-based analytics engine 420 includes multiple rule-based analytics models. Each rule-based analytics model can be built with a set of general-purpose rules for a type of project stored in the data store 410. The rule-based analytics engine 420 can determine a project type based on project metadata and select a corresponding rule-based analytics model to implement for analyzing the project related data for a current project. A user may customize the general-purpose rules by removing or modifying one or more the general-purpose rules, or adding new rules for specific user projects. The adopted or modified general-purpose rules and newly added rules constitute a set of project rules for a project.

A rule-based analytics model can analyze the project related data using the set of project rules. A rule includes at least one condition and a conclusion. A rule is triggered if the project data satisfies the conditions for the condition. For example, a rule specifies that if there is no response from the user to the user's counterparty for two weeks, then the project is at risk and further action is needed. If in a current sales project, the seller has not responded to a potential buyer's questions for two weeks, the rule mentioned above is triggered. Similarly, multiple rules can be triggered by the project data. In some examples, the rule-based analytics model can generate a notification including the triggered rules. In some examples, the rule-based analytics model can determine a risk score based on the triggered rules. Different rules may have different importance levels (e.g., weights), the rule-based analytics model may determine the risk score by weighting the triggered rules based on corresponding importance levels or based on pre-defined weights for corresponding rules for the project. The risk score can be a number between 0 and 10, a number between 0 and 100, a percentage between 0% and 100%. The higher the risk score is, the more imminent further actions are needed to be taken for the current user project. The notification can include triggered rules and a risk score. The notification can be displayed in a GUI of the communication analytics platform 310 via a client device 330 associated with the user. Alternatively, or additionally, the notification can be sent by email or text message to the user.

In some examples, the rule-based analytics engine 420 is also configured to recommend next-step actions based on the analysis of the project related data using the project rules. The recommended next-step actions can be a follow-up communication with the counterparties in the project, the rule-based analytics engine 420 can recommend a communication channel and generate content for the follow-up communication.

The rule-based analytics engine 420 can include a channel recommendation engine (not shown in FIG. 4) for recommending a communication channel for follow-up communication and a content generation engine (not shown in FIG. 4) for generating content for the follow-up communication. Alternatively, the channel recommendation engine and the content generation engine can be individual engines on the communication analytics platform, separate from the rule-based analytics engine 420. The channel recommendation engine is configured to recommend a communication channel for next-step communication for a user in a project. In some examples, the channel recommendation engine includes a classification model. The classification model can be a trained ML model. The trained ML model can be based on logistic regression, decision tree, random forest, support vector machine, K-nearest neighbor, naive Bayes, stochastic gradient descent, or any suitable ML algorithms for classification. Alternatively, the classification model can be a rule-based model. For example, a preferred channel is recommended based on a combination of project metadata, such as project stage or project size. If the project is at an early stage, chat or email channels can be recommended as preferred channels. If the project is at a late stage, an in-person meeting may be recommended. If the project has a high value (e.g., monetary or by other metrics), video or in-person meetings may be recommended. If the project has a low value, chat or email channels may be recommended. The ML model can be trained to weight the factors in the project metadata and generate rules based on weighted factors. In some examples, the classification model is trained in a supervised learning process. The ML model learns certain features from training data, including historical communication data, historical project metadata, and historical selected channels. In addition, the user may provide feedback on the recommended channels during implementation, such as user selection of one recommended channel over other recommended channels. The feedback data can be used to retrain the ML model to recommend more effective communication channels.

The content generation engine is configured to generate content for next-step communication based on previous communication data and the project metadata. In some examples, the content generation engine implements a pre-trained generative AI model, for example a pre-trained transformer model. The pre-trained generative AI model can be further trained to generate content for next-step communication using historical communication data and historical project metadata for past projects. The content generation engine can generate content for a selected channel for next-step communication. For example, if email is selected for next-step communication, the content generation engine can auto-populate certain information, for example, email recipient, title, salutation, or any suitable information. Meanwhile, the content generation engine also generates a body of the email, including key information to communicate with the recipient. Similarly, if a phone call is selected for the next-step communication, the content generation engine can generate a script for the phone call for the user to reference. A user may edit the style or substance of the content generated by the content generation engine. The generative AI model can be fine-tuned or retrained based on the edits.

The model store 430 includes different AI/ML models for analyzing project date and provide intelligence for user projects. Various types of models or artificial intelligence algorithms may be used in example systems. For example, simple machine learning models, such as Linear Regression and Gradient Boosting may be used. In other examples, more sophisticated models, such as Factorization Machines (“FM”). As more data is available in a system according to these examples, deep learning models may be utilized, such as DeepFM and Wide&Deep or other similar models. Other alternative machine-learning models that might be used include a deep convolutional neural network (“CNN”), a residual neural network (“Resnet”), or a recurrent neural network, e.g., long short-term memory (“LSTM”) models or gated recurrent units (“GRUs”) models. The machine-learning model can also be any other suitable machine-learning model, such as a three-dimensional CNN (“3DCNN”), a dynamic time warping (“DTW”) technique, a hidden Markov model (“HMM”), etc., or combinations of one or more of such techniques—e.g., CNN-HMM or MCNN (Multi-Scale Convolutional Neural Network). Further, some examples may employ adversarial networks, such as generative adversarial networks (“GANs”), or may employ autoencoders (“AEs”) in conjunction with machine-learning models, such as AEGANs or variational AEGANs (“VAEGANs”). In addition, the models or artificial intelligence algorithms in the model store can be supervised or unsupervised learning models.

The communication analytics platform 310 can select an AI/ML model from the model store 430. The AI/ML model can be trained to extract normal features and create a project profile (or pattern) using historical project related data and associated user-defined rules stored in the data store 410. The trained AI/ML model can recognize change of patterns and deviation from normal patterns for a project or a type of projects. The communication analytics platform 310 may train multiple AI/ML models for corresponding multiple types of projects. The multiple trained AI/ML models can also be stored in the model store 430.

The AI-based analytics engine 440 is configured to analyze project data using an AI-based analytics model. The AI-based analytics model can be a trained AI/ML model stored in the data store 410. The AI-based analytics model can determine a risk score for a current user project based on corresponding project related data. The AI-based analytics engine 440 can implement one trained AI/ML model corresponding to a general-purpose project. Alternatively, or additionally, the AI-based analytics engine 440 can implement multiple trained AI/ML models corresponding to multiple types of projects. During implementation, the AI-based analytics engine 440 can determine a project type for a current user project, and select a corresponding trained AI/ML model to analyze the project related data for the current user project. The trained AI/ML model can determine a risk level or score for the current user project based on the quality of communications, changes in pattern of communications, and other analysis result for the project related data. The risk score can be a number between 0 and 10, a number between 0 and 100, a percentage between 0% and 100%. The higher the risk score is, the more imminent further actions are needed to be taken for the current user project. The trained AI/ML model can be retrained or fine-tuned as more project related data is collected.

In some examples, the AI-based analytics engine 440 also recommends next-step actions based on the analysis of the project data by the AI-based analytics model. The recommended next-step actions can be a follow-up communication with the counterparties in the project. In some examples, a channel recommendation engine (not shown) of the communication analytics platform 310 can recommend a communication channel and a content recommendation engine (not shown) of the communication analytics platform 310 can generate content for the follow-up communication, as described earlier, after the AI-based analytics engine 440 determines a risk level of a project based on analyzing the project related data.

The rule-based analytics engine 420 and the AI-based analytics engine 440 can be used in series or in parallel for one user project to improve precision (e.g., accuracy of positive predictions) and recall (e.g., percentage of positive predictions). In some scenarios, rule-based analytics have better precision, while AI-based analytics have better recall, though in some examples the opposite may be true, or they may have similar results. In some examples, the two engines are used sequentially. The rule-based analytics engine 420 may first determine what user-defined rules are triggered, and then the AI-based analytics engine 440 may detect hidden issues in addition to the triggered rules. In some examples, the two engines run in parallel. When the output of the rule-based analytics engine 420 and the output of the AI-based analytics engine 440 substantially aligns with each other, the communication analytics platform 310 can present both or either one to the user without warning. When the output of the rule-based analytics engine 420 and the output of the AI-based analytics engine 440 deviates from each other, the communication analytics platform 310 may present both outputs to the user and highlight the difference with warning. In some examples, when the difference between the risk scores by the rule-based analytics engine 420 and by the AI-based analytics engine 440 are greater than a predetermined threshold (e.g., 20%, 20 out of 100, or 2 out of 10), the outputs are considered to be different.

For example, if both the rule-based analytics engine 420 and the AI-based analytics engine 440 indicates low risk level for a current project, the communication analytics platform can generate a green indicator for the current project indicating no further action is needed. If both the engines indicate high risk level for a current project, the communication analytics platform 310 can generate a red indicator for the current project indicating further action needs to be taken. If the risk levels indicated by the two engines are different by more than 20%, then the communication analytics platform 310 can generate a yellow indicator for the current project, indicating further action may be needed and the user may further review the current project.

In some examples, after the rule-based analytics engine 420 and the AI-based analytics engine 440 determines next-step communication is needed based on analyzing the project related data, other engines, such as a channel recommendation engine and a content generation engine on the communication analytics platform 310, either as part of the rule-based analytics engine 420 or the AI-based analytics engine 440 or as individual engines on the communication analytics platform 310, can recommend a communication channel and generate content for the next-step communication, as described earlier.

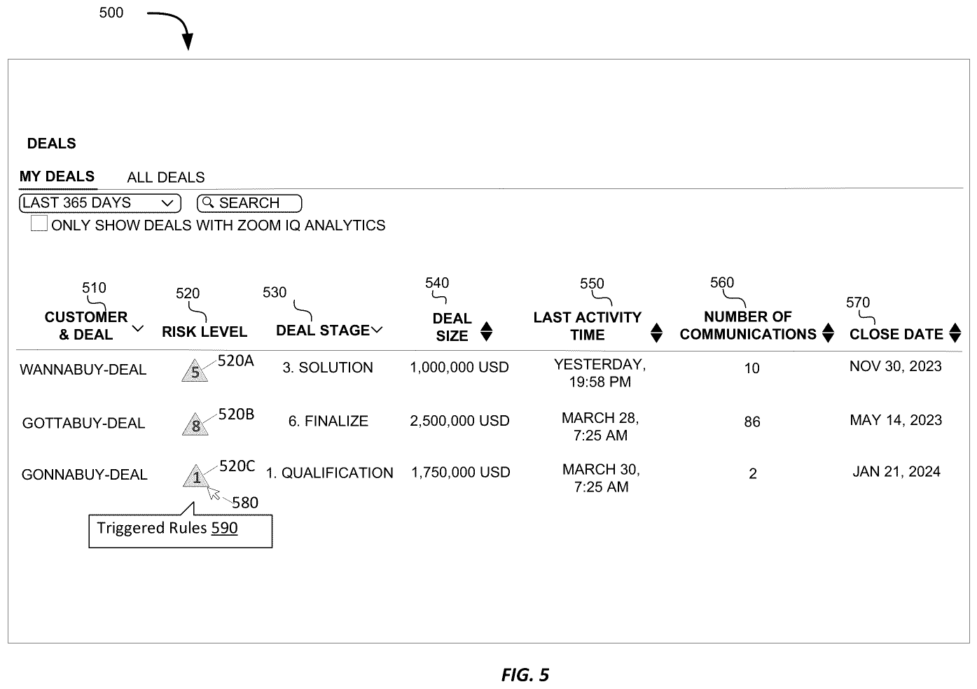

The client device 330 communicates with the communication analytics platform 310 via the communication analytics application 450 installed on the client device 330 and provided by the communication analytics platform 310. The communication analytics application 450 provides a graphical user interface (GUI) for the user to interact with the communication analytics platform 310, for example the GUIs in FIG. 5-8 as will be described below. The user may provide feedback on the determined risk level or the recommended next-step action, which can be transmitted to the communication analytics platform 310 and used for fine-tuning the rule-based analytics engine 420 and the AI-based analytics engine 440.

In some examples, the communication analytics application 450 installed on a client device 330 includes a rule-based analytics engine and an AI-based analytics engine customized for the user associated with the client device 330, even if the communication analytics platform 310 includes a rule-based analytics engine 420 and an AI-based analytics engine 440. In FIG. 4, the communication analytics application 450 includes a local data store 460, a customized rule-based analytics engine 470 and a customized AI-based analytics engine 480. When the communication analytics application 450 is first installed on the client device 330 associated with a user, the initial rule-based analytics engine includes a general-purpose rule-based analytics model using a set of general-purpose rules for a general-purpose project or a project type. The user may define specific rules for the user's projects or update the general-purpose rules for customization at the installation of the application or any time after installation. The initial AI-based analytics engine may include a trained ML model for a general-purpose project or a project type from the communication analytics platform 310. As the user interacts with the communication analytics application 450, the communication analytics application 450 collects user feedback on determined risk levels and recommended next-step actions, and other user data, for example, user actions either aligned with or different from the recommended next-step actions. The initial AI-based analytics engine can retrain or fine-tune the trained ML model for customization.

The local data store 460 can store project metadata and communication data of user projects for the user associated with the client device 330 and user-defined rules for the user projects. In addition, the local data store 460 can also store triggered rules, risk scores, notification messages to the user, and user action data following the notification (e.g., action or nonaction following the notification).

The customized rule-based analytics engine 470 or the customized AI-based analytics engine 480 in the communication analytics application 450 can further recommend a communication channel and generate content for the follow-up communication for a project if the project is determined to be at risk. Alternatively, or additionally, the communication analytics application 450 can include a channel recommendation engine for recommending a communication channel for follow-up communication and a content generation engine for generating content for the follow-up communication for a project, similar to the channel recommendation engine and the content generation engine on the communication analytics platform 310 as described above.

In some examples, the customized rule-based analytics engine 470 and the customized AI-based analytics engine 480 are on the communication analytics platform 310, or a remote server or a cloud server associated with the communication analytics platform 310. The communication analytics application 450 can access the initial rule-based analytics engine and the initial AI-based analytics engine, which are provided by the communication analytics platform 310 and located on the communication analytics platform 310 or associated remote server or cloud server. The initial rule-based analytics engine and the initial AI-based analytics engine can be customized with user specific data collected by the communication analytics application 450 and become customized rule-based analytics engine 470 and the customized AI-based analytics engine 480.

Referring now to FIG. 5, FIG. 5 is an example GUI 500 displaying a list of deals with corresponding indicators about triggered rules. The example GUI 500 is for the communication analytics application 450 installed on a client device 330. The list of deals includes the deal items extracted by the communication analytics platform 310 from a CRM platform or another third-party platform 340. For each deal item, the list includes a deal name 510, a deal stage 530, a deal size 540, last activity time 550, number of communications 560, and close date 570, which can be collectively referred to as deal metadata. The deal metadata may include other data not shown here, such as owner name of the counter parties, names of contact at the counter parties. Each deal item also includes a risk level 520, determined by the rule-based analytics engine 420 or AI-based analytics engine 440 generally as described in FIG. 4. In FIG. 5, the risk level for a corresponding deal is indicated by a warning sign and a number of triggered rules. In this example, the wannabuy-deal has a warning sign 520A showing five rule is triggered; the gottabuy-deal has a warning sign 520B showing eight rules are triggered; and the gonnabuy-deal has a warning sign 520C showing one rule is triggered. When a cursor 580 is placed at a warning sign, a hovering window may be displayed to present the triggered rules. In this example, the cursor 580 is placed at warning sign 520C for the gonnabuy-deal, a hovering window 590 is displayed to show the triggered rules for the gonnabuy-deal.

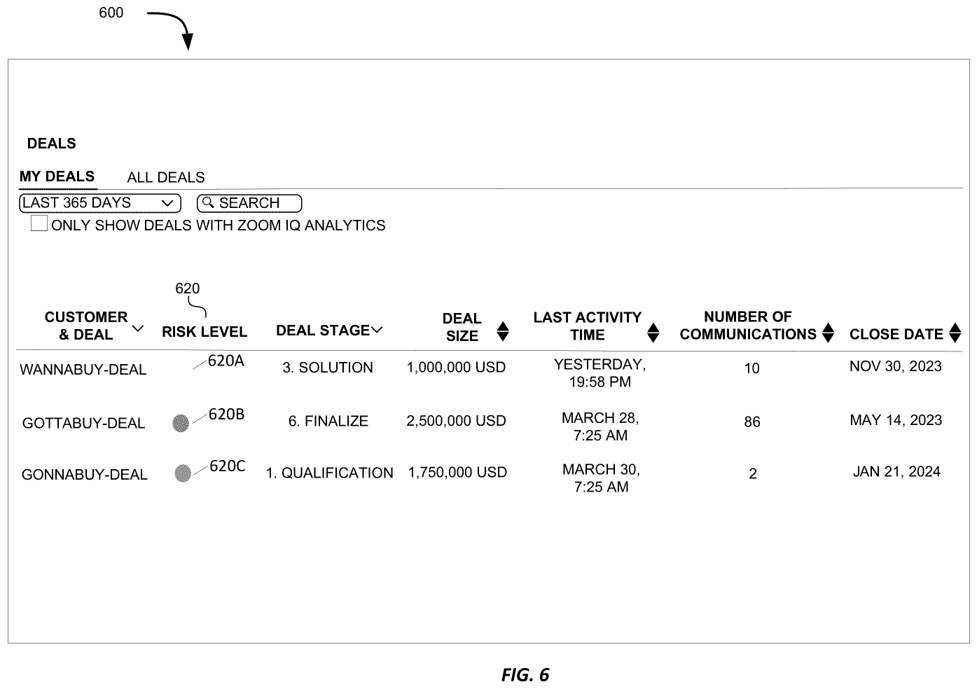

Referring now to FIG. 6, FIG. 6 is an example GUI 600 displaying a list of deals with corresponding indicators about risk levels. Similar to FIG. 5, the list of deals includes wannabuy-deal, gottabuy-deal, and gonnabuy-deal. Each deal has a corresponding risk level 620. In FIG. 5, the risk level for a corresponding deal is indicated by color. For example, the wannabuy-deal has an indicator 620A (yellow) indicating the project may be at risk and need further review; the gottabuy-deal has an indicator 620B (red) indicating the project is at risk and immediate action is needed; and the gonnabuy-deal has an indicator 620C (green) indicating the project is not at risk.

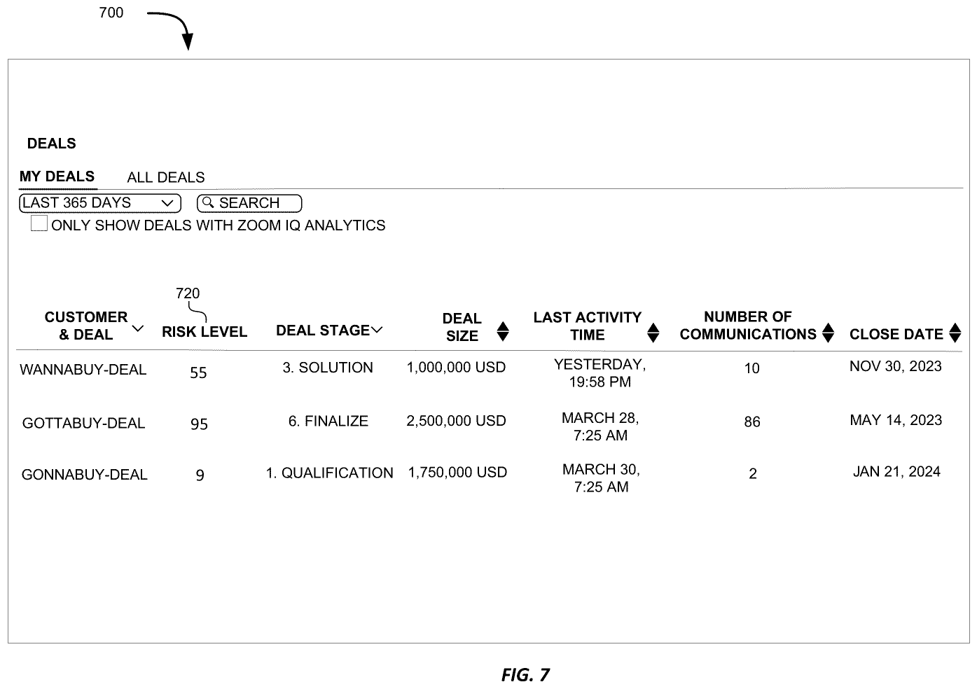

Referring now to FIG. 7, FIG. 7 is an example GUI 700 displaying a list of deals with corresponding indicators about risk scores. Similar to FIG. 5, the list of deals includes wannabuy-deal, gottabuy-deal, and gonnabuy-deal. Each deal has a corresponding risk level 720. In FIG. 7, the risk level for a corresponding deal is indicated by a risk score. The higher the risk score is, the more likely that a corresponding project is at risk. For example, the wannabuy-deal has a risk score 55 out of 100 indicating the project may be at risk and needs further review; the gottabuy-deal has a risk score 95 indicating the project is at risk and needs immediate action; and the gonnabuy-deal has a risk score 9 indicating the project is not at risk. Alternatively, the risk score can be a number between 0 and 10, a percentage between 0 and 100%, or in any other suitable format.

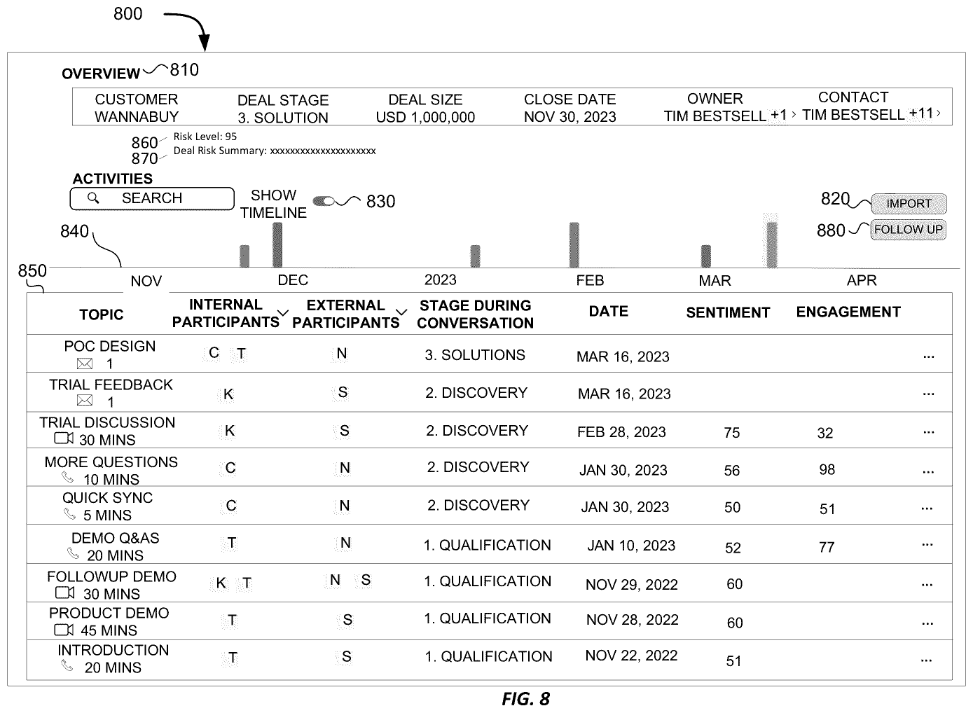

Referring now to FIG. 8, FIG. 8 is an example GUI 800 displaying a deal risk summary for a selected deal. A user can select a deal from the list of deals as shown in FIG. 5, 6, or 7 for more detailed information. In this example, the “wannabuy-deal” is selected for analysis. Some of the deal data for this deal is displayed in an overview 810, including the name of the counter party (e.g., customer name Wannabuy), deal stage (e.g., stage 3 solution), deal size (e.g., $1 million), close date (e.g., Nov. 30, 2023), owner of the deal (e.g., Tim Bestsell and one other persion is the owner of the deal), and names of contact for the deal (e.g., Tim Bestsell and 11 others (not shown)).

The GUI 800 includes an import button 820. When the user activates the import button 820, the user can select communication data to be imported related to a particular deal, for example the wannabuy-deal in FIG. 8. Alternatively, the communication data can be automatically imported and displayed in the GUI 800.

In FIG. 8, a list of imported communications related to the wannabuy-deal is displayed in a table 850. For each communication item, the table 850 includes a topic of the communication, the internal participants, external participants, deal stage at the time of the communication, date of the communication, sentiment indicator of the communication, and engagement indicator of the communication. The table 850 also includes a symbol for each communication indicating the communication type (e.g., video meetings, phone calls, emails, etc.) and a duration for each communication.

The imported communication data can also be displayed in a timeline by activating a Show Timeline button 830. In this example, the Show Timeline button 830 is activated, and all the imported communications are displayed in a timeline 840. The timeline 840 is a bar graph, where different types of communications are color coded and the height of the bars representing a duration of a communication or a combined duration of the same type of communications on the same day or adjacent days.

In addition, the example GUI 800 also displays a risk level 860 for the wannabuy-deal. In FIG. 8, the risk level 860 is 95 (out of 100). Alternatively, the risk level can be a number of triggered rules as displayed in FIG. 5, or a color coded indicator as displayed in FIG. 6. The example GUI 800 also includes a deal risk summary 870. The deal risk summary 870 may include the triggered rules or suggestions based on the deal risk and triggered rules. In some examples, the deal risk summary 870 also includes a recommended communication channel and content for the next-step communication.

The example GUI 800 includes a follow-up button 880. When a user activates the follow-up button 880, a GUI element (e.g., a pop-up window) can be displayed to present communication channels with recommendation indications. When a user selects a communication channel (e.g., the recommended communication channel), corresponding content can be displayed in another GUI element (e.g., a pop-up window). For example, the recommended communication channel is email. When the user selects the recommended communication channel, an email page can be activated, and suggested content from the analysis can be automatically filled in the body of the email page.

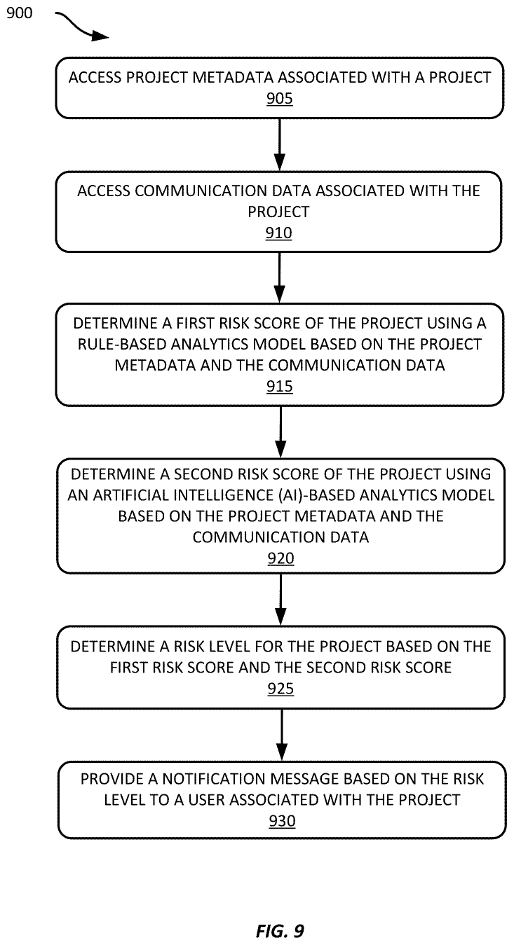

Referring now to FIG. 9, FIG. 9 shows an example method 900 for automatically analyzing project related data and facilitating actions for a project using rule-based and AI-based analytics models. The example method 900 will be discussed with respect to the system 300 shown in FIG. 3 and system 400 shown in FIG. 4; however, any suitable system for suggesting communication channels and generating corresponding contents for next-step communications may be used.

At block 905, a communication analytics platform 310 accesses project metadata associated with a project. The communication analytics platform 310 can be integrated with one or more third-party platforms 340 that manage projects, relationships, or business deals. A user associated with the project can transmit a permission to the communication analytics platform 310, via a communication analytics application 450 installed on a client device 330, for extracting project metadata associated with the project user from third-party platforms 340. The communication analytics platform 310 can extract a list of projects from a third-party platform 340. The project metadata associated with a project can include project name, project stage, project size, last activity time, number of communications, close date, parties in the project, contact information for different parities. The project metadata can be stored in a data store 410 on the communication analytics platform 310.

At block 910, the communication analytics platform 310 accesses communication data associated with the project. A client device 330 can select via a GUI of the communication analytics application 450 a project for analysis from the list of projects extracted from the third-party platforms 340. The client device 330 can transmit a request to the communication analytics platform 310 for importing certain communication data associated with the selected project. Alternatively, the communication analytics platform 310 can automatically import the communication data associated with the selected project for analysis.

At block 915, the communication analytics platform 310 determines a first risk score of the project using a rule-based analytics model based on the project metadata and the communication data. The rule-based analytics engine 420 of the communication analytics platform 310 can determine a first risk score of the project, generally as described in FIG. 4. For example, the rule-based analytics engine 420 implement a rule-based analytics model. The rule-based analytics model includes multiple rules for the project. A set of general-purpose rules can be selected for the rule-based analytics model based on a type of the project, a user associated with the project can modify one or more rules in the set of general-purpose rules. In addition, the user associated with the project can define a new rule for the project. The multiple rules included in the rule-based analytics model can be weighted. The rule-based analytics model can determine a rule is triggered based on the project metadata and the communication data and determine a risk score of the project based on the number of triggered rules and corresponding weights.

At block 920, the communication analytics platform 310 determines a second risk score of the project using an AI-based analytics model based on the project metadata and the communication data. The AI-based analytics engine 440 of the communication analytics platform 310 can determine a second risk score of the project, generally as described in FIG. 4. For example, the AI-based analytics engine 440 uses an AI/ML model trained with historical project related data for historical projects to create a project profile with normal features for a project type. The trained AI/ML model can recognize change of patterns and deviation from normal patterns for a current project based on the project profile for a corresponding project type and determines a risk level or score for the current project based on the quality of communications, changes in pattern of communications, and other analysis result for the project related data.

At block 925, the communication analytics platform 310 determines a risk level of the project based on the first risk score and the second risk score. The communication analytics platform 310 can compare the first risk score from block 915 and the second risk score from block 920 to determine a difference between these two scores. If the difference is less than a threshold value, the risk level of the project is a level corresponding to the first risk score or the second risk score. The risk level based on the first risk score or the second risk score can be a low risk level, a medium risk level, or a high risk level. If the difference is equal to or greater than a threshold value, the risk level of the project may not be determined. An indication can be provided to the user associated with the project, for example a yellow indicator, indicating that further review by the user associated the project is needed. For example, the first risk score is 40 out of 100 (low risk) and the second risk score is 70 out of 100 (high risk), the threshold value is 20. The different between the two risk scores is 30, which is greater than the threshold value 20. Then, the communication analytics platform 310 concludes that the risk level of the project is undetermined and generates an indication to the user associated with the project for further review.

At block 930, the communication analytics platform 310 provides a notification message based on the risk level to a user associated with the project. If risk level determines at block 930 satisfies a threshold, the communication analytics platform 310 can generate a notification message to the user associated with the project. The threshold can be medium risk, high risk, or undetermined. In other words, the risk level is medium risk, high risk, or undetermined, a notification message is provided to the user associated with the project. The notification message can be displayed in a GUI of the communication analytics application 450, or in a form of email or text message. the notification message can include the risk level determined at block 925 and a risk summary. The risk summary can include a list of triggered rules.

The user associated with the project may review the notification message and take certain actions as needed. If the communication analytics platform determines follow-up communication is needed based on the risk level, a recommendation of communication channel and content for the follow-up communication may be automatically generated and included in the risk summary. Alternatively, or additionally, the user associated with the project may request the communication analytics platform 310 to recommend a communication channel and generated content for follow-up communication.

Even though blocks 905-930 of method 900 in FIG. 9 are performed by the communication analytics platform 310 as described above, the client device 330 installed with the communication analytics application 450 can also perform method 900. For example, the customized rule-based analytics engine 470 of the communication analytics application 450 on the client device 330 can determine a first risk score based on project metadata and communication data, similar to the rule-based analytics engine 420 on the communication analytics platform 310. Also for example, the customized AI-based analytics engine 480 of the communication analytics application 450 on the client device can generate content for the next-step communication based on the project metadata and communication data, similar to the AI-based analytics engine 440 on the communication analytics platform 310.

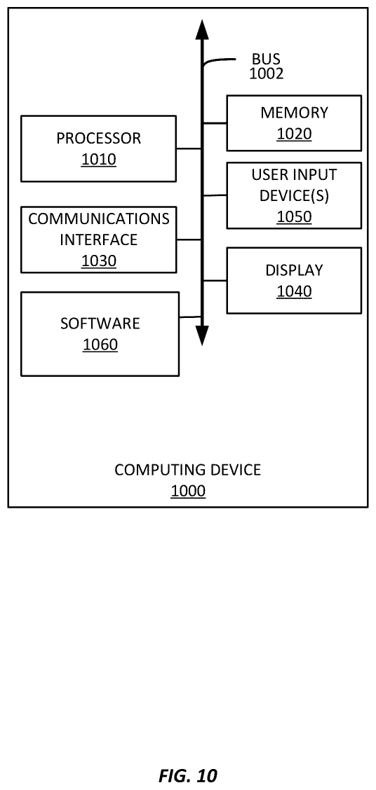

Referring now to FIG. 10, FIG. 10 shows an example computing device 1000 suitable for use in example systems or methods for automatically analyzing project related data and facilitating actions for a project using rule-based and AI-based analytics models. The example computing device 1000 includes a processor 1010 which is in communication with the memory 1020 and other components of the computing device 1000 using one or more communications buses 1002. The processor 1010 is configured to execute processor-executable instructions stored in the memory 1020 to perform one or more methods for automatically analyzing and facilitating interactions using rule-based and AI-based analytics models, according to different examples. In some embodiments, the computing device may include software 1060 for executing one or more methods described herein. The computing device 1000, in this example, also includes one or more user input devices 1050, such as a keyboard, mouse, touchscreen, microphone, etc., to accept user input. The computing device 1000 also includes a display 1040 to provide visual output to a user.

The computing device 1000 also includes a communications interface 1030. In some examples, the communications interface 1030 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random-access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
accessing, by a communication analytics platform, project metadata associated with a project;
accessing, by the communication analytics platform, communication data associated with the project;
determining, by the communication analytics platform using a rule-based analytics model, a first risk score of the project based on the project metadata and the communication data, wherein the rule-based analytics model comprises a plurality of rules for the project;
determining, by the communication analytics platform using an artificial intelligence (AI)-based analytics model, a second risk score of the project based on the project metadata and the communication data;
determining, by the communication analytics platform, a risk level of the project based on the first risk score and the second risk score; and
providing a notification message based on the risk level to a user associated with the project.

2. The method of claim 1, wherein the project is managed via a third-party platform, wherein the communication analytics platform is integrated with the third-party platform, and wherein the project metadata comprises project name, project stage, project size, last activity time, number of communications, close date, parties in the project, contact information for different parities.

3. The method of claim 1, wherein the communication data is related to one or more communication occurrences associated with the project, wherein the communication data comprises channel information, communication content, communication date, communication time, communication duration, and communication parties for the one or more communication occurrences.

4. The method of claim 1, further comprising:
determining a project type for the project based on the project metadata;
selecting a set of general-purpose rules corresponding to the project type for the rule-based analytics model; and
receiving a modification for the set of general-purpose rules from the user associated with the project.

5. The method of claim 1, further comprising:
receiving a new rule defined by the user associated with the project.

6. The method of claim 1, further comprising:
determining a rule of the plurality of rules is triggered based on the project metadata and the communication data to obtain one or more triggered rules; and
determining the first risk score of the project based on the one or more triggered rules.

7. The method of claim 1, wherein determining a risk level of the project based on the first risk score and the second risk score comprises:
after determining a difference between the first risk score and the second risk score is less than a threshold value, determining that the risk level is a level corresponding to the first risk score or the second risk score, wherein the risk level comprises a low risk level, a medium level, or a high risk level.

8. The method of claim 1, wherein determining a risk level of the project based on the first risk score and the second risk score comprises:
after determining a difference between the first risk score and the second risk score is equal to or greater than a threshold value, determining that the risk level is undetermined with an indication that further review by the user associated with the project is needed.

9. The method of claim 1, further comprising providing the notification message to the user associated with the project in response to determining that the risk level satisfies a threshold, wherein the notification message comprises the risk level and a risk summary, wherein the risk summary comprises a list of triggered rules of plurality of rules.

10. The method of claim 1, further comprising:
determining a recommendation of a communication channel for next-step communication for the project based on the risk level to obtain a recommended communication channel; and
generating content for the next-step communication via the recommended communication channel.

11. A system comprising:
a communications interface;
a non-transitory computer-readable medium; and
one or more processors communicatively coupled to the communications interface and the non-transitory computer-readable medium, the one or more processors configured to execute processor-executable instructions stored in the non-transitory computer-readable medium to:
access project metadata associated with a project;
access communication data associated with the project;
determine a first risk score of the project using a rule-based analytics model based on the project metadata and the communication data, wherein the rule-based analytics model comprises a plurality of rules for the project;
determine a second risk score of the project using an artificial intelligence (AI)-based analytics model based on the project metadata and the communication data;
determine a risk level of the project based on the first risk score and the second risk score; and
provide a notification message based on the risk level to a user associated with the project.

12. The system of claim 11, wherein the one or more processors are configured to execute further processor-executable instructions stored in the non-transitory computer-readable medium to:
determine a project type for the project based on the project metadata;
select a set of general-purpose rules corresponding to the project type for the rule-based analytics model; and
receive a modification for the set of general-purpose rules from the user associated with the project.

13. The system of claim 11, wherein the one or more processors are configured to execute further processor-executable instructions stored in the non-transitory computer-readable medium to:
receive a new rule defined by the user associated with the project.

14. The system of claim 11, wherein the one or more processors are configured to execute further processor-executable instructions stored in the non-transitory computer-readable medium to:
determine a rule of the plurality of rules is triggered based on the project metadata and the communication data to obtain one or more triggered rules; and
determine the first risk score of the project based on the one or more triggered rules.

15. The system of claim 11, wherein the one or more processors are configured to execute further processor-executable instructions stored in the non-transitory computer-readable medium to:
in response to determining a difference between the first risk score and the second risk score is less than a threshold value, determine that the risk level is a level corresponding to the first risk score or the second risk score, wherein the risk level comprises a low risk level, a medium level, or a high risk level.

16. The system of claim 11, wherein the one or more processors are configured to execute further processor-executable instructions stored in the non-transitory computer-readable medium to:
in response to determining a difference between the first risk score and the second risk score is equal to or greater than a threshold value, determine that the risk level is undetermined with an indication that further review by the user associated with the project is needed.

17. The system of claim 11, wherein the one or more processors are configured to execute further processor-executable instructions stored in the non-transitory computer-readable medium to:
determine a recommendation of a communication channel for next-step communication for the project based on the risk level to obtain a recommended communication channel; and
generate content for the next-step communication via the recommended communication channel.

18. A non-transitory computer-readable medium comprising processor-executable instructions configured to cause one or more processors to:
access project metadata associated with a project;
access communication data associated with the project;
determine a first risk score of the project using a rule-based analytics model based on the project metadata and the communication data, wherein the rule-based analytics model comprises a plurality of rules for the project;
determine a second risk score of the project using an artificial intelligence (AI)-based analytics model based on the project metadata and the communication data;
determine a risk level of the project based on the first risk score and the second risk score; and
provide a notification message based on the risk level to a user associated with the project.

19. The non-transitory computer-readable medium of claim 18, further comprising processor-executable instructions configured to cause one or more processors to:
determine a rule of the plurality of rules is triggered based on the project metadata and the communication data to obtain one or more triggered rules; and
determine the first risk score of the project based on the one or more triggered rules.

20. The non-transitory computer-readable medium of claim 18, further comprising processor-executable instructions configured to cause one or more processors to:
provide the notification message to the user associated with the project in response to determining that the risk level satisfies a threshold, wherein the notification message comprises the risk level and a risk summary, wherein the risk summary comprises a list of triggered rules of the plurality of rules.
